(19) United States
(12) Patent Application Publication
(10) Pub. No.: US 2014/0359097 A1
(43) Pub. Date: Dec. 4, 2014

(54) In Line Network Connection Control Device

(71) Applicant: Henry Thomas Parks, Martinez, GA (US)

(72) Inventor: Henry Thomas Parks, Martinez, GA (US)

(21) Appl. No.: 13/864,099

(22) Filed: Apr. 16, 2013

(51) Int. Cl. H04L 12/24

(52) U.S. Cl. CPC H04L 41/50
USPC 709/223

(57) ABSTRACT

The invention provides for an in-line network connection control device that controls the physical and logical connectivity of Ethernet attached end devices, switches or routers. The device allows two mechanisms of for controlling connectivity of Ethernet attached devices; General Purpose Input Output (GPIO) controlled, 1) latched and 2) non-latched.

Non-latched relay—the non-latched relay is triggered by closing the electrical circuit between the common ground screw terminal and the non-latched screw terminal.

Latched relay—the latched relay is triggered by closing the electrical circuit between the common ground screw terminal and the latched screw terminal.

This device is designed to be used in line, to allow GPIO external control of network connectivity and data flow. A typical use for this appliance is to control Video On Demand traffic flows by controlling Ethernet connectivity of the end service device.

### CROSS REFERENCE TO RELATED APPLICATIONS

This device may be used to control or secure any network attached device via GPIO (General Purpose Input Output) contact closures. Applications for this device are as follows:
1. Controlled starting and stopping multicast or unicast video traffic connecting via an Ethernet connection to a switch, router, or other network connected device.
2. Securing access to network attached end devices or Stub networks by disconnecting the device or stub network from the main switch, router or network device via triggered GPIO (General Purpose Input Output) contact.

Connect termination may be latched (Permanent disconnect until GPIO reset is initiated) or non-latched (disconnected until GPIO contact is released).

### HISTORY AND SUMMARY OF THE INVENTION

This invention was designed initially designed to interface a Public Address speaker system with Video Over IP traffic, allowing multicast and unicast video traffic to halt during message announcement by disconnecting the Video server from the network when announcements or alarms are generated, and resume video server network connections when alarms or announcements are over. Application for this device easily lands itself to securing or isolating any network attached device when General Purpose IO (GPIO) alarms or triggers are activated.

### BRIEF DESCRIPTION OF THE SEVERAL VIEWS OF THE DRAWING (IF ANY)

FIG. 1

FIG. 1 shows typical “Inline Network Connection Control Device”, use for controlling end device network connectivity via GPIO trigger alarms.

FIG. 2

FIG. 2 shows typical “Inline Network Connection Control Device”, use for controlling Switch to router network connectivity via GPIO trigger alarms.

FIG. 3

FIG. 3 shows typical “Inline Network Connection Control Device”, use for controlling network to network connectivity (router to router) via GPIO trigger alarms.

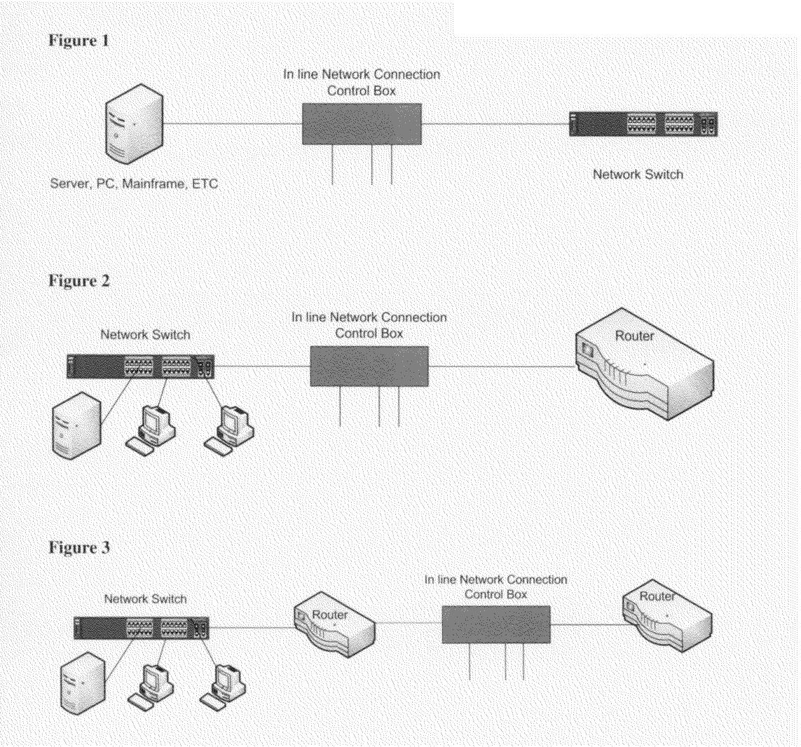

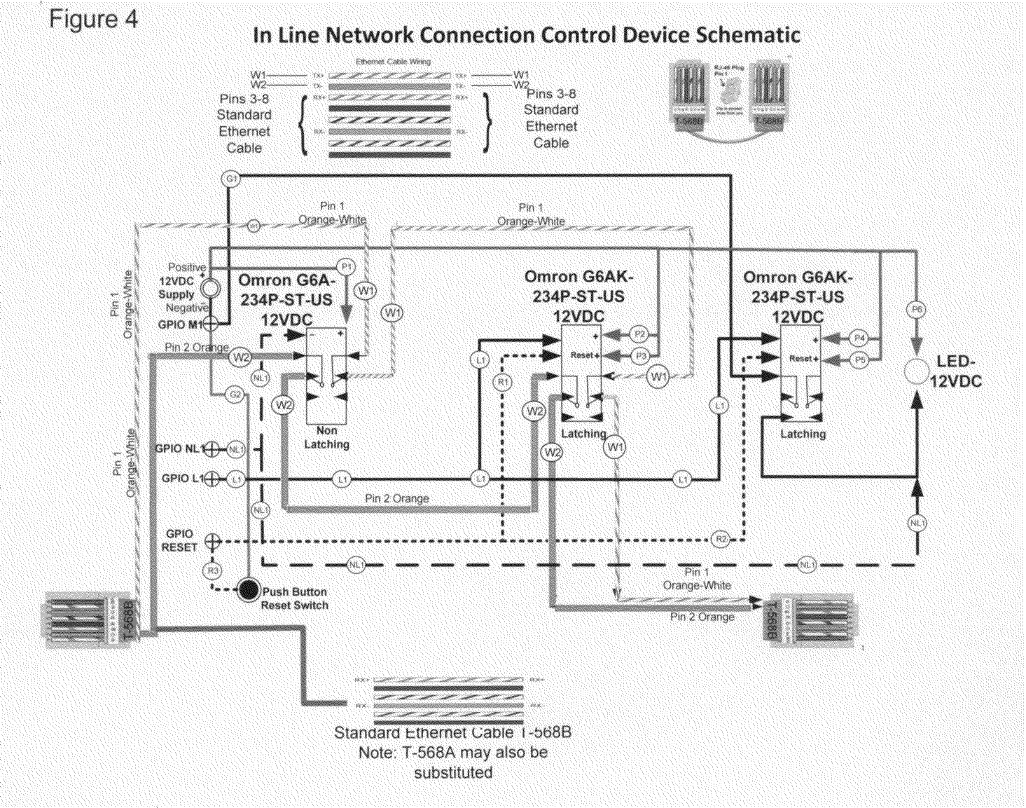

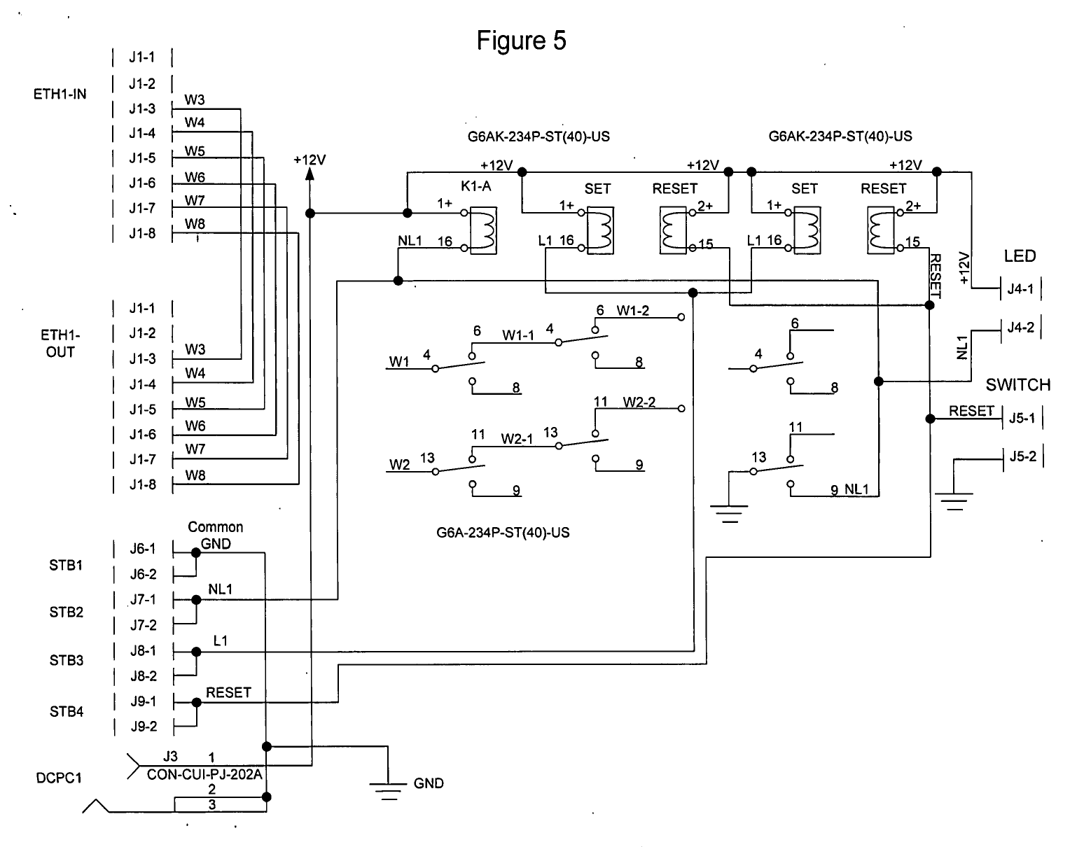

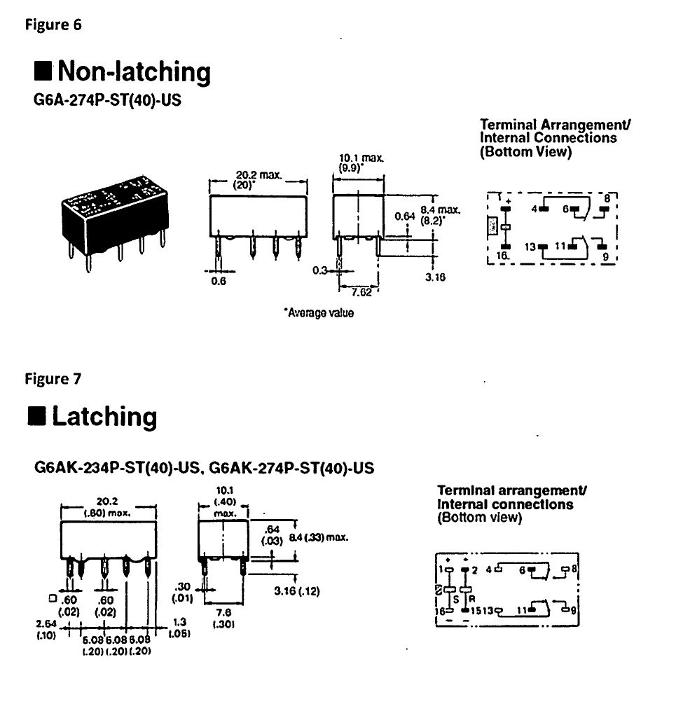

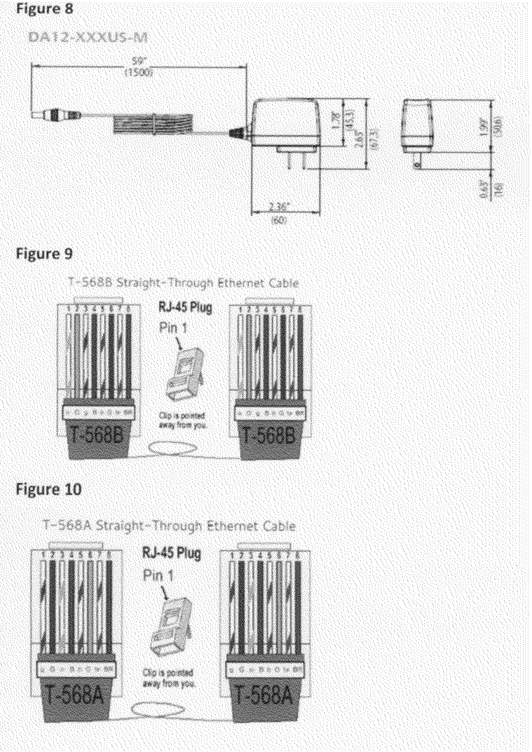

### DETAILED DESCRIPTION OF THE INVENTION

The Inline Network Connection Control Device disconnects and reconnects Ethernet based devices from networks or other Ethernet capable end devices, by the physical controlling the connectivity of the transmit pairs (T-568B Pin 1, orange-white, and pin 2, Orange) of a standard Ethernet cable.

FIG. 4

FIG. 4 shows the Inline Network Connection Control Device detailed schematic identifying internal double pole, double throw latching relay used in prototype (Omron G6AK-234P-ST US 21 VDC; other similar electrical or solid state relays may be substituted) and double pole double throw non-latching (Omron G6AK-234P-ST-US 21 VDC; other similar electrical or solid state relays may be substituted) relay connectivity with Ethernet Cable transmit pins 1 and pins 2 (T-568B standard; T-568A standard may also be used).

FIG. 5

FIG. 5 is the same drawing as FIG. 4 above, only utilizing electrical drawing symbols to depict schematic.

The physically connectivity of each pair is controlled by completing the circuit between the Common Ground General Purpose Input-Output terminal (GPIO) and the Latched or Non-Latched terminal poles.

Closing completing the circuit to the Non-Latched Trigger terminal pole will trigger the latched love voltage relay, causing pins one (1) and pin two (2) to be physical disconnected. The Non-Latched relay will remain open as long as the Common Ground Terminal is connected to the Non-Latched terminal.

FIG. 6

FIG. 6 shows the Omron G6A-234P-ST-US, 12 VDC, double pole, double throw, non-latching relay used in the prototype device (similar compatible relays may be used).

Closing/completing the circuit to the Latched Trigger terminal pole will trigger the latched love voltage relay, causing pins one (1) and pin two (2) to be physical disconnected. The latched relay will remain open until the Latched Trigger reset button or Latched Trigger Reset Terminal pole is connected to the Common Ground pole.

FIG. 7

FIG. 7 Shows the Omron G6AK-234P-ST-US, 12 VDC, double pole, double throw, latching relay used in the prototype device (similar compatible relays may be used).

Power to the device is provided by a 12 VDC Output Emerson Network Power Plug-in AC Adapter. Part umber utilized in the prototype is MFG PN: DA12-120US-M, FIG. 8. Compatible power supplies may be used.

Ethernet Cable

Standard T-568B Cabling is recommended and utilized in prototype device. T-568B Ethernet cable is commercially available off the shelf.

FIG. 9

FIG. 9 shows the standard pin out for T-568B Ethernet Cable. Commercially available or self manufactured T-568B cables may be used.

Note: Ethernet cabling standard T-568A may be substituted utilizing corresponding transmit pairs to T-568B.

FIG. 10

FIG. 10 shows standard pin out for T-568A Ethernet Cable.

1. An inline device for controlling network connectivity between end devices, networks and routers by controlling the layer one, physical connectivity of transmit pairs, pin 1 and pin 2 on Ethernet networks.

2. An inline device for controlling data transmission of end devices, networks, and routers by controlling the layer one, physical connectivity of transmit pairs pin 1 and pin 2 on Ethernet networks.

3. An inline device for securing end devices, networks and routes by controlling the layer one, physical connectivity on Ethernet networks.
